(19) United States
(12) Patent Application Publication
(10) Pub. No.: US 2009/0207495 A1
(43) Pub. Date: Aug. 20, 2009

(54) Wavelength separation film and filter for optical communication using the same

(76) Inventors: Yoshimasa YAMAGUCHI, Otsu-city (JP); Masaaki KADOMI, Otsu-city (JP)

Correspondence Address: KUBOVCIK & KUBOVCIK, SUITE 1105, 1215 SOUTH CLARK STREET, ARLINGTON, VA, 22202, US

(21) Appl. No.: 12/318,137

(22) Filed: Dec. 22, 2008

(30) Foreign Application Priority Data
Dec. 25, 2007 (JP) 2007-332589

(51) Int. Cl. G02B 5/28; G02B 1/10

(52) U.S. Cl. 359/588; 359/586

(57) ABSTRACT

A wavelength separation film having a structure containing plural thin films laminated to each other including a first thin film containing a high refractive index material, a second thin film containing a low refractive index material, and a third thin film containing a material having an intermediate refractive index that intervenes between the refractive index of the high refractive index material and the refractive index of the low refractive index material, the high refractive index material being silicon, the low refractive index material being at least one selected from silicon oxide, magnesium fluoride and aluminum oxide, and the material having an intermediate refractive index being at least one selected from titanium oxide, tantalum oxide, niobium oxide, zirconium oxide, hafnium oxide and aluminum oxide.

### BACKGROUND OF THE INVENTION

1. Field of the Invention

The present invention relates to a wavelength separation film capable of transmitting light having a passband wavelength and reflecting light having a stopband wavelength, and a filter for optical communication using the same.

2. Related Art

As an optical communication module that sends and receives light transmitted bidirectionally with an optical fiber, such a module has been known that has a light separation prism provided on an optical axis on an apical surface of an optical fiber, in which the light separation prism transmits light having a first wavelength in the optical axis direction and reflects light having a second-wavelength in the perpendicular direction to the optical axis (see, for example, JP-A-2000-180671). The light separation prism has provided therein a wavelength separation film inclined at an angle of from 40 to 50° with respect to the incident direction of the light. The wavelength separation film has a structure containing a first thin film formed of a material having a high refractive index and a second thin film formed of a material having a low refractive index laminated alternately. Conventionally, TiO₂ has been generally used as the first thin film having a high refractive index, and SiO₂ has been generally used as the second thin film having a low refractive index. The thin films are laminated alternately in about 60 layers to constitute the wavelength separation film.

In the wavelength separation film constituted by laminating the thin films of TiO₂ and SiO₂, however, there is a problem that the wavelengths of the passband and the stopband are shifted when the incident angle of the light incident on the wavelength separation film is deviated, thereby failing to provide the intended optical characteristics.

Transmitted light and reflected light formed from light incident on the inclined wavelength separation film are separated into a P polarized component and an S polarized component, which are different from each other in optical characteristics. In the conventional wavelength separation film, the separation width between the P polarized component and the S polarized component is as large as about 300 nm, and the intended characteristics in the passband can be satisfied only by the P polarized component.

JP-A-2000-162413 discloses a light separation prism having a wavelength separation film that contains a TiO₂ thin film or a SiO₂ thin film laminated alternately with a Si thin film. In the laminated thin film, however, when the total number of the high refractive index thin films and the low refractive index thin films is decreased, there is a problem that the stopband is narrowed, and the wavelength shift widths of the passband and the stopband are increased on deviation of the light incident angle.

### SUMMARY OF THE INVENTION

An object of the invention is to provide a wavelength separation film that can decrease the total number of the laminated films, can decrease the thickness of each of the laminated films, can decrease the separation width in optical characteristics between the P polarized component and the S polarized component formed from light incident on the inclined wavelength separation film, can decrease the wavelength shift widths of the passband and the stopband on deviation of the light incident angle, can enhance the stopband as compared to conventional ones, and can decrease the transmission loss due to absorption with Si by decreasing the total thickness of Si, and also to provide a filter for optical communication using the wavelength separation film.

The wavelength separation film of the invention has a structure containing plural thin films laminated to each other including a first thin film containing a high refractive index material, a second thin film containing a low refractive index material, and a third thin film containing a material having an intermediate refractive index that intervenes between the refractive index of the high refractive index material and the refractive index of the low refractive index material, the high refractive index material being silicon, the low refractive index material being at least one selected from silicon oxide, magnesium fluoride and aluminum oxide, and the material having an intermediate refractive index being at least one selected from titanium oxide, tantalum oxide, niobium oxide, zirconium oxide, hafnium oxide and aluminum oxide.

The wavelength separation film of the invention has the structure containing the plural thin films laminated to each other including the first thin film, the second thin film and the third thin film, thereby providing the following advantages.

(1) The total number of films laminated can be decreased, and the thickness of each of the laminated films can be decreased. Accordingly, the total thickness of the wavelength separation film can be decreased as compared to conventional ones.

(2) The separation width in optical characteristics between the P polarized component and the S polarized component formed from light incident on the inclined wavelength separation film can be decreased.

(3) The wavelength shift widths of the passband and the stopband on deviation of the light incident angle can be decreased.

(4) The stopband can be enhanced as compared to conventional ones.

(5) The total thickness of Si can be decreased to decrease the transmission loss due to absorption with Si as compared to a conventional wavelength separation film using a Si film.

According to the invention, the first thin film has a large difference in refractive index from the second thin film and the third thin film, and therefore, the total number of films laminated can be decreased. For example, a conventional wavelength separation film having SiO₂ thin films and TiO₂ thin films laminated has a lamination number of 44 layers and a thickness of about 10 μm, whereas the wavelength separation film of the invention has a lamination number of about from 30 to 36 layers and a total thickness of about 5 μm.

A conventional wavelength separation film having Si thin films and SiO₂ thin films or TiO₂ thin films laminated has a lamination number of the Si thin films of 14 layers and a thickness of about 1,400 nm, whereas according to the invention, the lamination number of Si thin films can be about 10 layers, and the total thickness can be about 800 nm.

According to the invention, the thickness of thin films laminated can be decreased, and the total number of films laminated can be decreased, whereby the production process can be simplified as compared to conventional ones.

It is preferred in the invention that the first thin film, the second thin film and the third thin film are laminated in such a manner that the first thin film is adjacent to the second thin film or the third thin film.

In the invention, the third thin film may contain plural thin films laminated to each other. Specifically, the third thin film may be constituted by laminating thin films of one kind selected from titanium oxide, tantalum oxide, niobium oxide, zirconium oxide, hafnium oxide and aluminum oxide, or laminating thin films of two or more kinds selected therefrom. The second thin film in the invention is formed with at least one kind of a low refractive index material selected from silicon oxide, magnesium fluoride and aluminum oxide, and in the case where the third thin film contains aluminum oxide, the second thin film contains silicon oxide or magnesium oxide.

The first thin film in the invention is formed with a silicon thin film. The silicon thin film has a refractive index that can be varied by changing the method and conditions for forming the thin film. The silicon thin film in the invention preferably has a refractive index in a range of from 2.85 to 4.20 at a wavelength of 1,490 nm. In the case where the refractive index is too small, the stopband may be narrowed, and the separation width in optical characteristics between the P polarized component and the S polarized component may be increased, in some cases. In the case where the refractive index is too small, the density of the thin film is generally decreased to receive influence of absorption of water and the like, whereby the resistance to environments may be lowered in some cases. The resistance to environments of the silicon thin film can be enhanced by increasing the refractive index thereof. However, too high the refractive index of the silicon thin film may increase ripple in the optical characteristics.

In the invention, the thickness of each of the thin films is appropriately selected depending on the setting of the passband and the stopband and thus is not particularly limited. In general, the thickness is selected from a range of from 50 to 300 nm, and a thin film having a thickness exceeding the range may be used in some cases. The total number of the thin films laminated is not particularly limited and may be, for example, in a range of from 20 to 50 layers.

The method for forming the thin films in the invention is not particularly limited, and for example, such a thin film forming method as a vacuum deposition method and a sputtering method may be used.

The filter for optical communication of the invention has the wavelength separation film of the invention disposed to be inclined with respect to a light incident direction, whereby light having a wavelength in the passband of the wavelength separation film is transmitted, and light having a wavelength in the stopband thereof is reflected.

In the filter for optical communication of the invention, the wavelength separation film is preferably disposed to be inclined with respect to the light incident angle at an angle of from 40 to 50°.

Examples of the filter for optical communication of the invention include a wavelength separation prism and a wavelength separation plate described later.

According to the invention, the total number of the laminated films can be decreased, the thickness of each of the laminated films can be decreased, the separation width in optical characteristics between the P polarized component and the S polarized component formed from light incident on the inclined wavelength separation film can be decreased, the wavelength shift widths of the passband and the stopband on deviation of the light incident angle can be decreased, the stopband can be enhanced as compared to conventional ones, and the transmission loss due to absorption with Si can be decreased by decreasing the total thickness of Si.

### BRIEF DESCRIPTION OF THE DRAWINGS

FIG. 1 is a schematic cross sectional view showing a wavelength separation prism as an embodiment of the filter for optical communication according to the invention.

FIG. 2 is a schematic cross sectional view showing an optical communication module using the wavelength separation prism of the example shown in FIG. 1.

FIG. 3 is a schematic cross sectional view showing a wavelength separation plate as an embodiment of the filter for optical communication according to the invention.

FIG. 4 is a schematic cross sectional view showing an optical communication module using the wavelength separation plate of the example shown in FIG. 3.

FIG. 5 is a graph showing the optical characteristics of the wavelength separation film of Example 1 according to the invention.

FIG. 6 is a graph showing the optical characteristics of the wavelength separation film of Example 2 according to the invention.

FIG. 7 is a graph showing the optical characteristics of the wavelength separation film of Example 3 according to the invention.

FIG. 8 is a graph showing the optical characteristics of the wavelength separation film of Example 4 according to the invention.

FIG. 9 is a graph showing the optical characteristics of the wavelength separation film of Example 5 according to the invention.

FIG. 10 is a graph showing the optical characteristics of the wavelength separation film of Example 6 according to the invention.

FIG. 11 is a graph showing the optical characteristics of the wavelength separation film of Example 7 according to the invention.

FIG. 12 is a graph showing the optical characteristics of the wavelength separation film of Example 8 according to the invention.

FIG. 13 is a graph showing the optical characteristics of the wavelength separation film of Example 9 according to the invention.

FIG. 14 is a graph showing the optical characteristics of the wavelength separation film of Example 10 according to the invention.

FIG. 15 is a graph showing the optical characteristics of the wavelength separation film of Example 11 according to the invention.

FIG. 16 is a graph showing the optical characteristics of the wavelength separation film of comparative Example 1.

FIG. 17 is a graph showing the optical characteristics of the wavelength separation film of comparative Example 2.

FIG. 18 is a graph showing the optical characteristics of the wavelength separation film of comparative Example 3.

FIG. 19 is a graph showing the optical characteristics of the wavelength separation film of Example 12 according to the invention.

FIG. 20 is a graph showing the optical characteristics of the wavelength separation film of Example 13 according to the invention.

### DESCRIPTION OF THE PREFERRED EMBODIMENTS

The invention will be described with reference to specific examples below, but the invention is not limited to them.

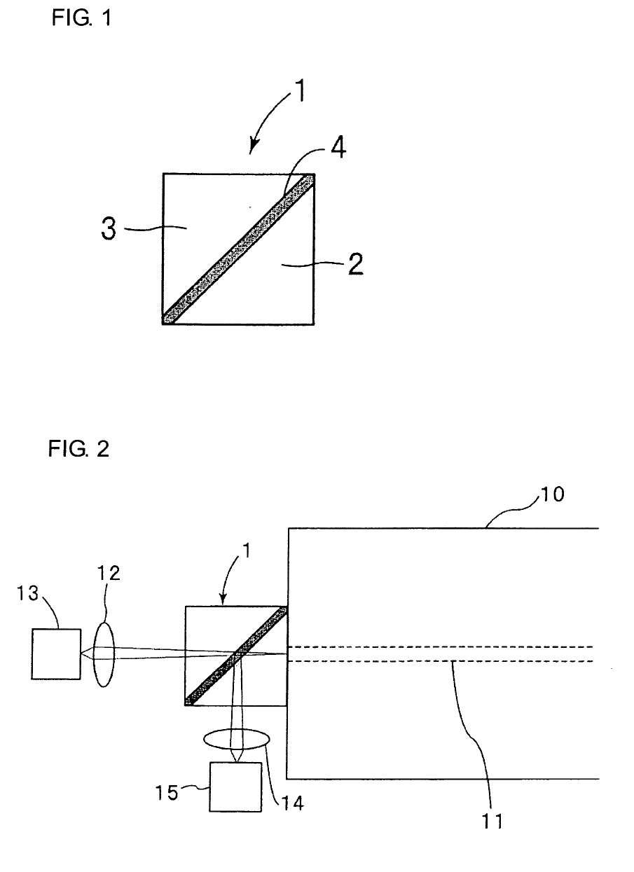

FIG. 1 is a schematic cross sectional view showing a wavelength separation prism as an embodiment of the filter for optical communication according to the invention. As shown in FIG. 1, the wavelength separation prism 1 is constituted by prism chips 2 and 3 each having a right-angle isosceles triangular column shape and being formed of glass or the like, which are adhered at the inclined planes thereof through a wavelength separation film 4. The prism chips may be adhered, for example, by using an ultraviolet ray-curing adhesive. The wavelength separation film 4 according to the invention is formed on the inclined plane of one of the prism chips to be adhered, thereby disposing the wavelength separation film 4 on the inclined planes of the prism chips 2 and 3.

FIG. 2 is a schematic cross sectional view showing an optical communication module using the wavelength separation prism shown in FIG. 1. The wavelength separation prism 1 is adhered to an end of a ferrule 10 with an ultraviolet ray-curing adhesive. An optical fiber 11 is provided in the ferrule 10. Light having a wavelength of 1,490 nm emitted from a laser diode (LD) 13 as a light emitting device is focused with a lens 12 and is incident on the wavelength separation prism 1. The light incident on the wavelength separation prism 1 has a wavelength within the passband of the wavelength separation film 4, and thus the light is transmitted through the wavelength separation film 4, is incident on the end of the optical fiber 11 and is transmitted in the optical fiber 11.

Light having a wavelength of 1,310 nm emitted from the optical fiber 11 is incident on the wavelength separation prism 1. The light has a wavelength within the stopband of the wavelength separation film 4, and thus the light is reflected by the wavelength separation film 4 and is incident on a photodiode (PD) 15 as a light receiving device through a lens 14 disposed below.

As described above, the wavelength separation film 4 of the wavelength separation prism 1 is set so as to transmit the light emitted from the LD 13 and to reflect the light emitted from the optical fiber 1, thereby enabling bidirectional communication using the optical fiber 11.

In the wavelength separation prism 1, the wavelength separation film 4 is disposed to be inclined, for example, with respect to the optical axis connecting the optical fiber 11 and the LD 13 at an angle of 45°. However, the light emitted from the LD 13 is incident on the optical fiber 11 while condensed by the lens 12, but is incident on the wavelength separation film 4 with some broadening. For example, the incident light has a broadening angle of +5° with respect to the incident angle of 45°. Since the light having a broadening angle of ±5° with respect to the incident angle of 45° is incident on the wavelength separation film 4, intended optical characteristics may not be obtained in some cases if the wavelengths of the passband and the stopband are largely shifted on deviation of the incident angle of the light.

The wavelength separation film of the invention can decrease the wavelength shift widths of the passband and the stopband on deviation of the light incident angle as described above, thereby reducing influence of deviation of the light incident angle on the optical characteristics. Furthermore, the stopband can be enhanced as compared to conventional ones, whereby the design and administrative latitudes can be enhanced to facilitate provision of intended optical characteristics.

The wavelength separation film of the invention can decrease the separation width in optical characteristics between the P polarized component and the S polarized component formed from light incident on the inclined wavelength separation film. Accordingly, sufficient passband characteristics can be provided for both the P polarized component and the S polarized component.

The wavelength separation prism 1 is adhered to the end of the ferrule 10 in the example shown in FIG. 2, but the wavelength separation prism 1 may be disposed between the ferrule 10 and the lens 12.

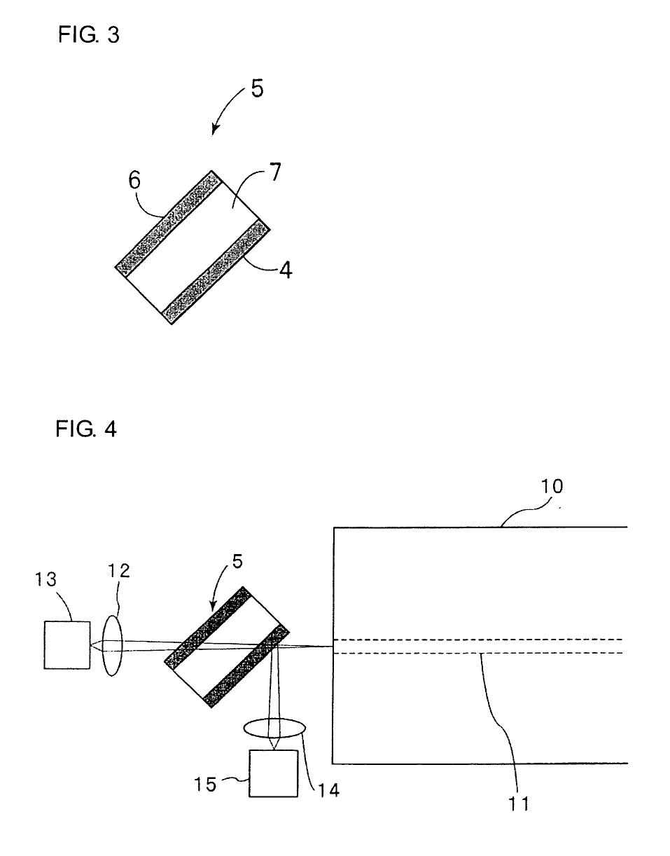

FIG. 3 is a schematic cross sectional view showing a wavelength separation plate using a wavelength separation film according to the invention. As shown in FIG. 3, the wavelength separation plate 5 is constituted by a transparent substrate 7 formed of glass or the like, having formed on one surface thereof a wavelength separation film 4 and formed on the other surface thereof an antireflection film (AR film)₆. The wavelength separation film 4 may be a wavelength separation film according to the invention, and the antireflection film 6 may be, for example, a four-layer film containing TiO₂ or Ta₂O₅ films and SiO₂ films alternately. In the wavelength separation prism 1 shown in FIG. 2, an antireflection film is preferably provided on the side of LD 13 with respect to the wavelength separation film 4.

FIG. 4 is a schematic cross sectional view showing an optical communication module using the wavelength separation plate 5 shown in FIG. 3. In the optical communication module shown in FIG. 4, the wavelength separation plate 5 is disposed in such a manner that the wavelength separation film 4 and the AR film 6 are inclined with respect to the optical axis connecting the optical fiber 11 and the LD 13 at an angle of 45°. In the optical communication module shown in FIG. 4, the light emitted from the LD 13 can be incident on and transmitted in the optical fiber 11, and the light emitted from the optical fiber 11 can be reflected by the wavelength separation film 4 to be incident on the PD 15, as similar to the optical communication module shown in FIG. 2.

In the optical communication module shown in FIG. 4, the light incident on the wavelength separation film 4 of the wavelength separation plate 5 also has a broadening angle, for example, of ±5° with respect to the incident angle of 45°. By using the wavelength separation film according to the invention, however, the wavelength shift widths of the passband and the stopband on deviation of the light incident angle can be decreased, and thus decrease in optical characteristics on deviation of the incident angle can be suppressed. Furthermore, the stopband can be enhanced as compared to conventional ones to facilitate provision of intended optical characteristics.

The wavelength separation film of the invention can decrease the separation width in optical characteristics between the P polarized component and the S polarized component formed from light incident on the inclined wavelength separation film as described above. Accordingly, sufficient passband characteristics can be provided for both the P polarized component and the S polarized component.

### Examples 1 to 11 and Comparative Examples 1 to 3

The first thin film, the second thin film and the third thin film were formed on a glass substrate with the materials for films shown in Table 1 below according to the order and thickness shown in Tables 2 and 3 below to prepare wavelength separation films.

As shown in Table 1, Examples 7 to 11 used as the third thin film a single layer thin film containing one of a Nb₂O₅ film, a ZrO₂ film, a TiO₂ film, a Ta₂O₅ film and a HfO₂ film, or a double layer thin film containing one of these films and an Al₂O₃ film.

In Examples and Comparative Examples, the thin films each were formed by a vacuum deposition method. The total thicknesses of the wavelength separation films were as shown in Tables 2 and 3.

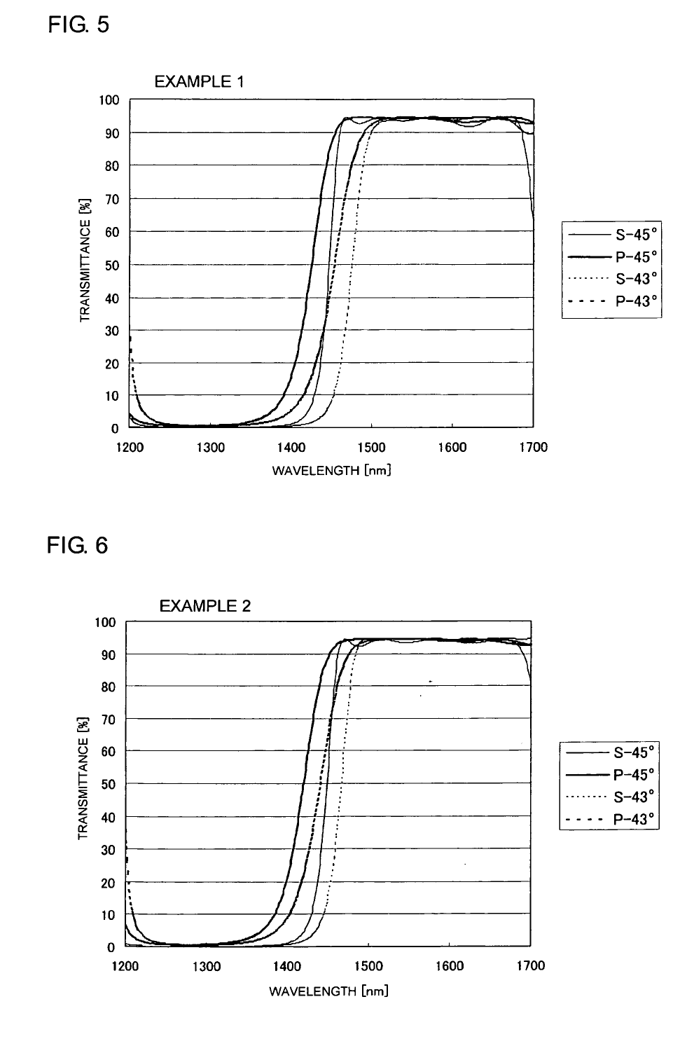

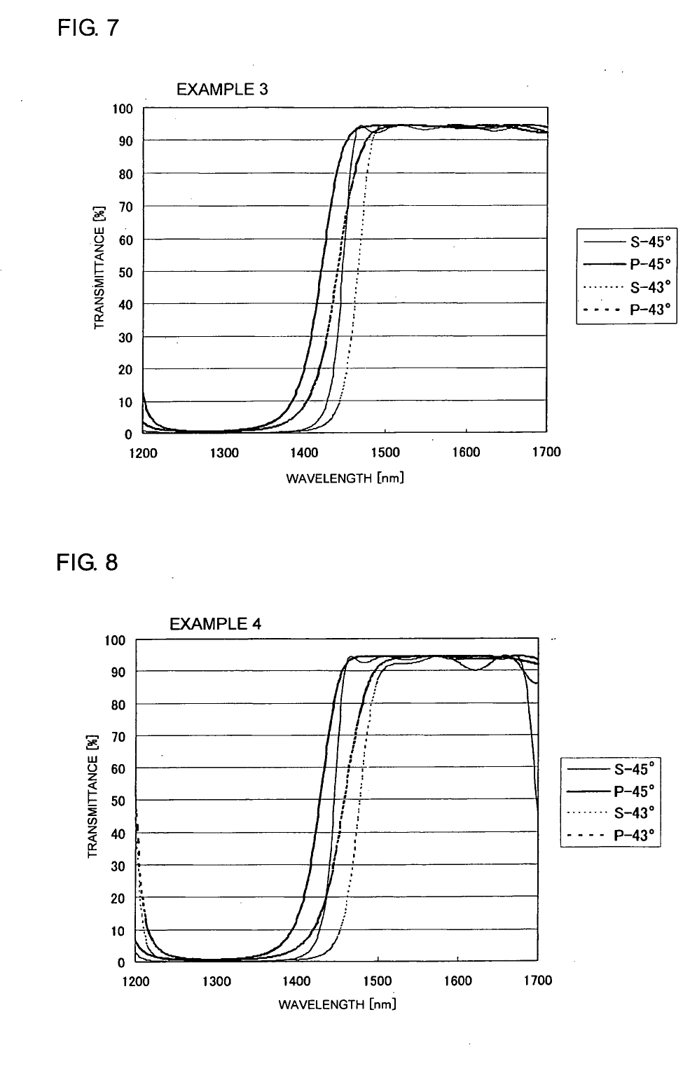

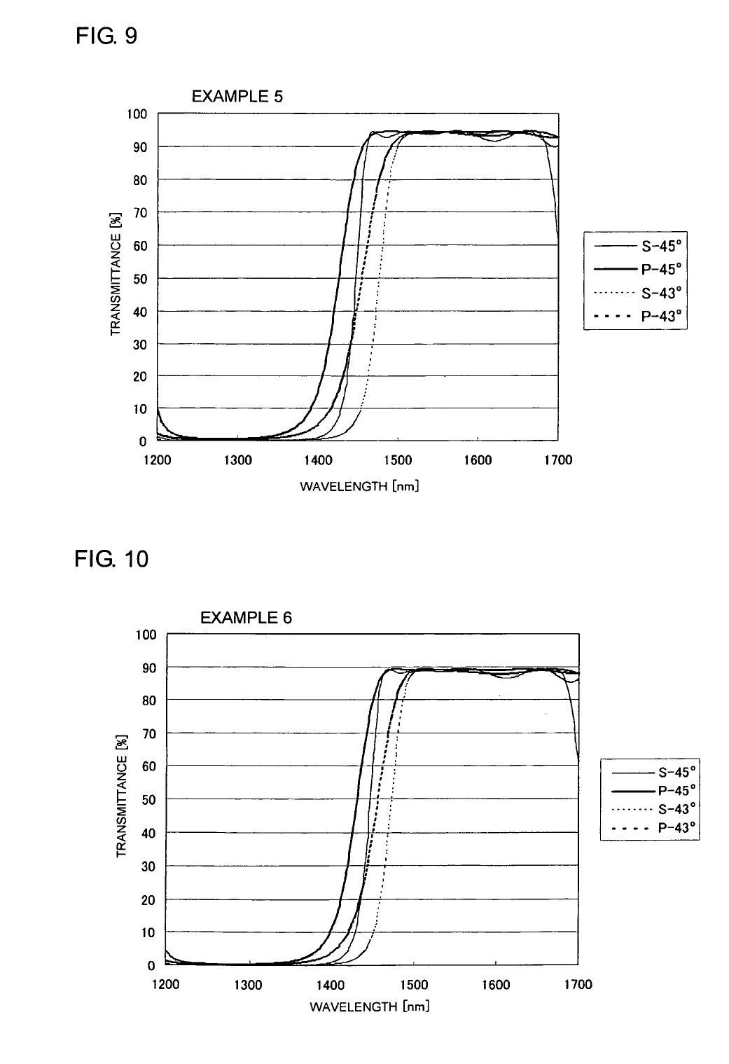

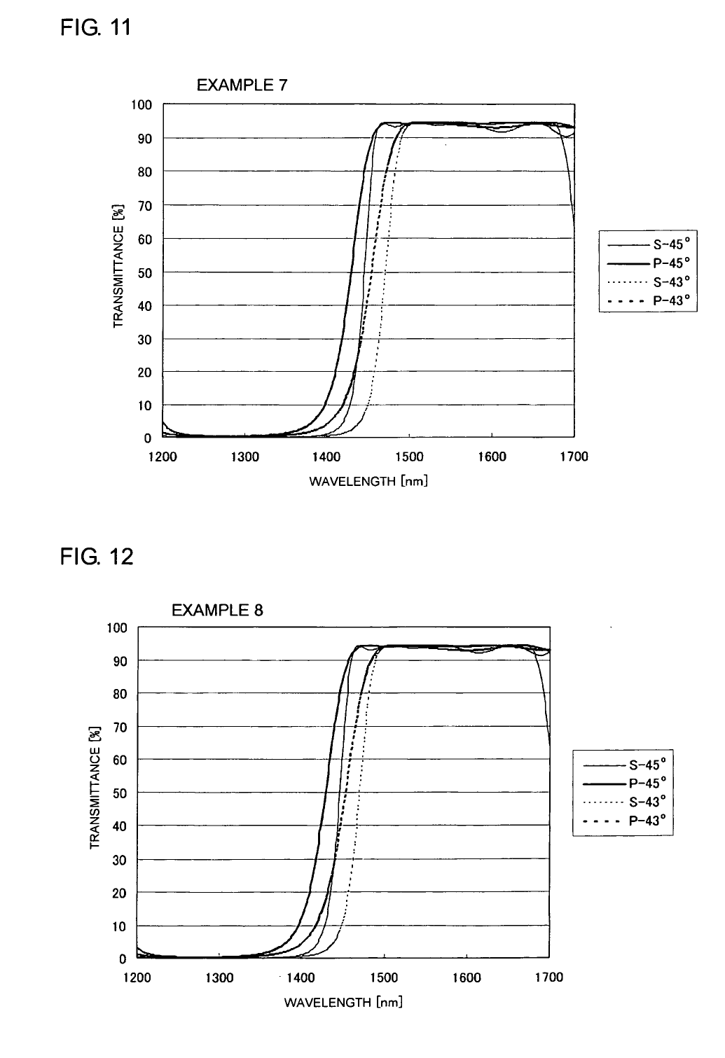

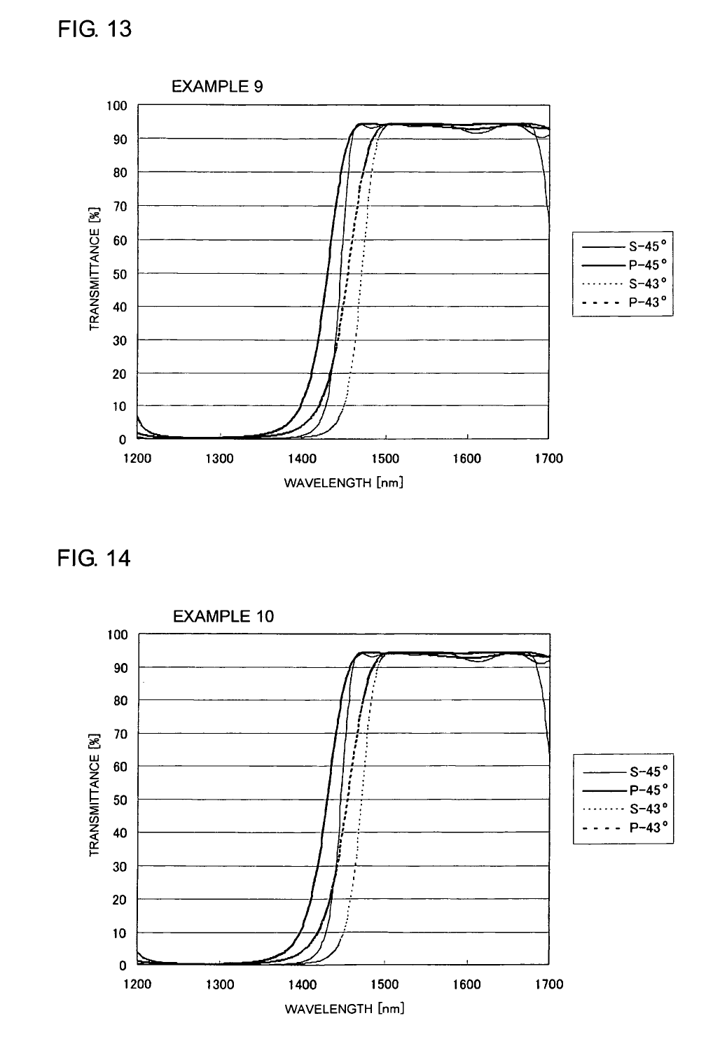

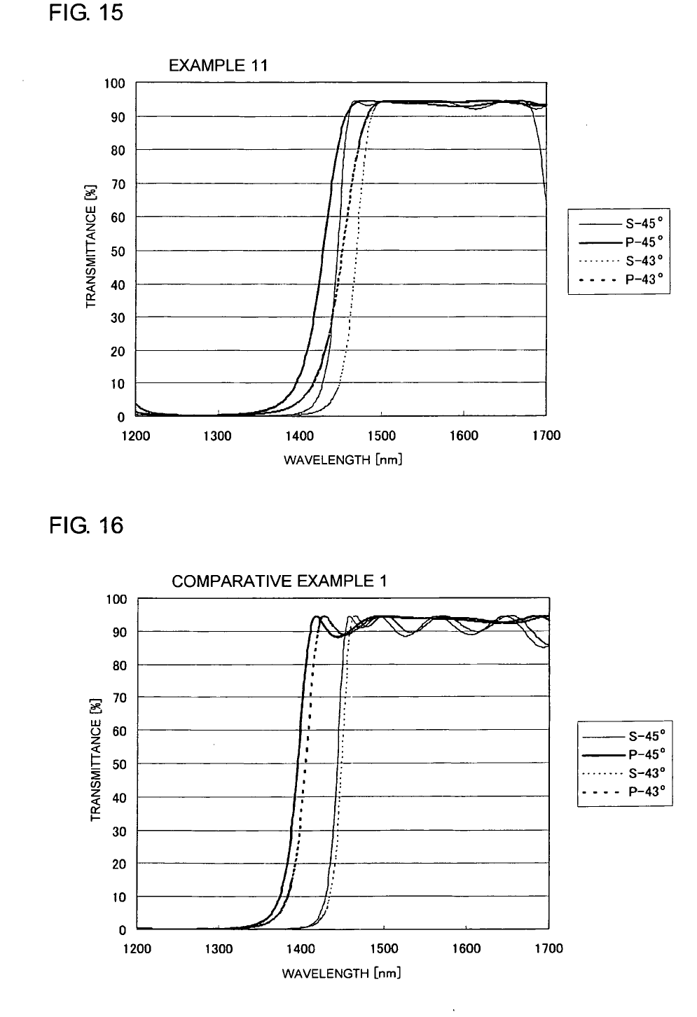

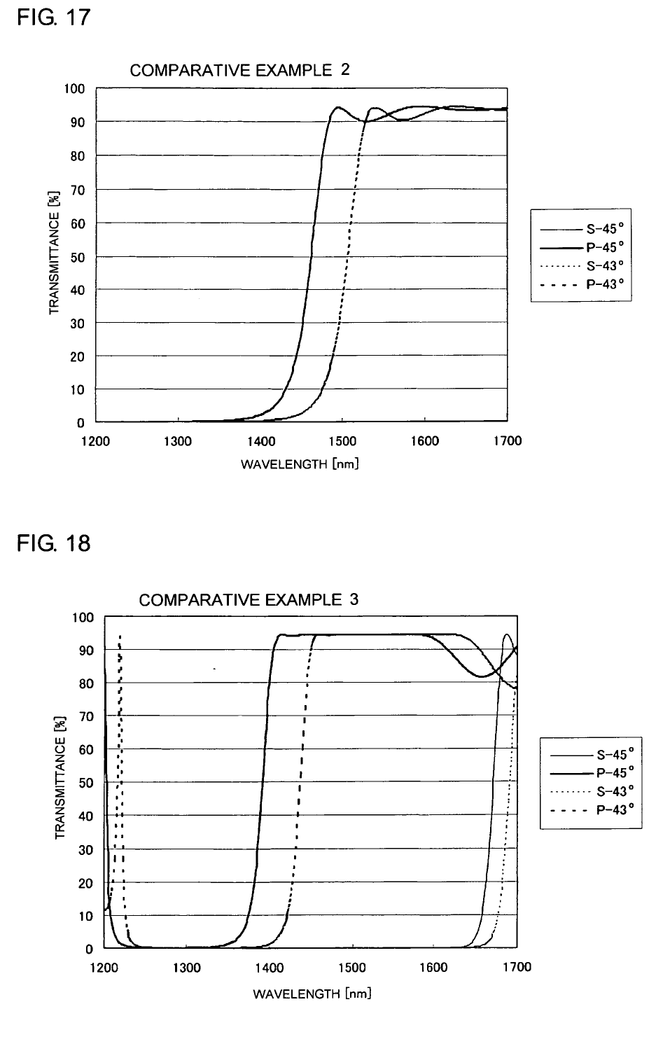

TABLE 1

| | First | | | Graph |
|---|---|---|---|---|
| | Thin | Second | | of Optical |
| | Film | Thin Film | Third Thin Film | Characteristics |
| Example 1 | Si | SiO₂ | Ta₂O₅ | FIG. 5 |
| Example 2 | Si | SiO₂ | TiO₂ | FIG. 6 |
| Example 3 | Si | Al₂O₃ | Ta₂O₅ | FIG. 7 |
| Example 4 | Si | MgF₂ | Ta₂O₅ | FIG. 8 |
| Example 5 | Si | SiO₂ | ZrO₂ | FIG. 9 |
| Exampie 6 | Si | SiO₂ | Nb₂O₅ | FIG. 10 |
| Example 7 | Si | SiO₂ | Nb₂O₅ and/or Al₂O₃ | FIG. 11 |
| Example 8 | Si | SiO₂ | ZrO₂ and/or Al₂O₃ | FIG. 12 |
| Exampie 9 | Si | SiO₂ | TiO₂ and/or Al₂O₃ | FIG. 13 |
| Example 10 | Si | SiO₂ | Ta₂O₅ and/or Al₂O₃ | FIG. 14 |
| Example 11 | Si | SiO₂ | HfO₂ and/or Al₂O₃ | FIG. 15 |
| Comp. Ex. 1 | Si | SiO₂ | — | FIG. 16 |
| Comp. Ex. 2 | Si | TiO₂ | — | FIG. 17 |
| Comp. Ex. 3 | TiO₂ | SiO₂ | — | FIG. 18 |

TABLE 2

| | Example 1 | | Example 2 | | Example 3 | | Example 4 | | Example 5 | | | | | |
|---|---|---|---|---|---|---|---|---|---|---|---|---|---|---|
| | | Thick- | | Thick- | | Thick- | | Thick- | | Thick- | Example 6 | | Example 7 | |
| | Material | ness | Material | ness | Material | ness | Material | ness | Material | ness | Material | Thickness | Material | Thickness |
| | of Film | (nm) | of Film | (nm) | of Film | (nm) | of Film | (nm) | of Film | (nm) | of Film | (nm) | of Film | (nm) |
| Layer 1 | SiO₂ | 212 | SiO₂ | 195 | Al₂O₃ | 80 | MgF₂ | 196 | SiO₂ | 229 | SiO₂ | 226 | SiO₂ | 211 |
| Layer 2 | Si | 80 | Si | 80 | Si | 80 | Si | 80 | Si | 80 | Si | 80 | Si | 80 |
| Layer 3 | Ta₂O₅ | 84 | TiO₂ | 94 | Ta₂O₅ | 86 | Ta₂O₅ | 76 | ZrO₂ | 77 | Nb₂O₅ | 81 | Nb₂O₅ | 93 |
| Layer 4 | Si | 80 | Si | 80 | Si | 80 | Si | 80 | Si | 80 | Si | 80 | Si | 80 |
| Layer 5 | SiO₂ | 80 | SiO₂ | 94 | Al₂O₃ | 85 | MgF₂ | 80 | SiO₂ | 81 | SiO₂ | 80 | Al₂O₃ | 199 |
| Layer 6 | Ta₂O₅ | 228 | TiO₂ | 180 | Ta₂O₅ | 194 | Ta₂O₅ | 258 | ZrO₂ | 262 | Nb₂O₅ | 226 | Nb₂O₅ | 111 |
| Layer 7 | Si | 80 | Si | 80 | Si | 80 | Si | 80 | Si | 80 | Si | 80 | Si | 80 |
| Layer 8 | SiO₂ | 556 | SiO₂ | 595 | Al₂O₃ | 487 | MgF₂ | 531 | SiO₂ | 500 | SiO₂ | 500 | Al₂O₃ | 204 |
| Layer 9 | Ta₂O₅ | 207 | TiO₂ | 188 | Ta₂O₅ | 184 | Ta₂O₅ | 228 | ZrO₂ | 230 | Nb₂O₅ | 218 | SiO₂ | 300 |
| Layer 10 | Si | 80 | Si | 80 | Si | 80 | Si | 80 | Si | 80 | Si | 80 | Al₂O₃ | 186 |
| Layer 11 | SiO₂ | 124 | SiO₂ | 111 | Al₂O₃ | 80 | MgF₂ | 142 | SiO₂ | 151 | SiO₂ | 156 | Nb₂O₅ | 90 |
| Layer 12 | Ta₂O₅ | 167 | TiO₂ | 150 | Ta₂O₅ | 172 | Ta₂O₅ | 181 | ZrO₂ | 178 | Nb₂O₅ | 151 | Si | 80 |
| Layer 13 | Si | 80 | Si | 80 | Si | 80 | Si | 80 | Si | 80 | Si | 80 | Al₂O₃ | 123 |
| Layer 14 | Ta₂O₅ | 78 | TiO₂ | 52 | Ta₂O₅ | 115 | Ta₂O₅ | 73 | ZrO₂ | 84 | Nb₂O₅ | 67 | Nb₂O₅ | 113 |
| Layer 15 | SiO₂ | 495 | SiO₂ | 531 | Al₂O₃ | 446 | MgF₂ | 500 | SiO₂ | 500 | SiO₂ | 500 | Si | 80 |
| Layer 16 | Ta₂O₅ | 169 | TiO₂ | 168 | Ta₂O₅ | 116 | Ta₂O₅ | 193 | ZrO₂ | 168 | Nb₂O₅ | 170 | Nb₂O₅ | 66 |
| Layer 17 | Si | 80 | Si | 80 | Si | 80 | Si | 80 | Si | 80 | Si | 80 | Al₂O₃ | 168 |
| Layer 18 | Ta₂O₅ | 79 | TiO₂ | 21 | Ta₂O₅ | 172 | Ta₂O₅ | 53 | ZrO₂ | 105 | Nb₂O₅ | 50 | SiO₂ | 300 |
| Layer 19 | SiO₂ | 333 | SiO₂ | 412 | Al₂O₃ | 80 | MgF₂ | 419 | SiO₂ | 283 | SiO₂ | 372 | Al₂O₃ | 167 |
| Layer 20 | Si | 80 | Si | 80 | Si | 80 | Si | 80 | Si | 80 | Si | 80 | Nb₂O₅ | 69 |
| Layer 21 | Ta₂O₅ | 194 | TiO₂ | 176 | Ta₂O₅ | 184 | Ta₂O₅ | 206 | ZrO₂ | 213 | Nb₂O₅ | 200 | Si | 80 |
| Layer 22 | SiO₂ | 561 | SiO₂ | 575 | Al₂O₃ | 487 | MgF₂ | 583 | SiO₂ | 541 | SiO₂ | 530 | Nb₂O₅ | 108 |
| Layer 23 | Si | 80 | Si | 80 | Si | 80 | Si | 80 | Si | 80 | Si | 80 | Al₂O₃ | 131 |
| Layer 24 | Ta₂O₅ | 200 | TiO₂ | 170 | Ta₂O₅ | 194 | Ta₂O₅ | 222 | ZrO₂ | 236 | Nb₂O₅ | 205 | Si | 80 |
| Layer 25 | SiO₂ | 124 | SiO₂ | 125 | Al₂O₃ | 80 | MgF₂ | 107 | SiO₂ | 100 | SiO₂ | 95 | Nb₂O₅ | 111 |
| Layer 26 | Si | 80 | Si | 80 | Si | 80 | Si | 80 | Si | 80 | Si | 80 | Al₂O₃ | 154 |
| Layer 27 | Ta₂O₅ | 75 | TiO₂ | 76 | Ta₂O₅ | 74 | Ta₂O₅ | 73 | ZrO₂ | 72 | Nb₂O₅ | 73 | SiO₂ | 300 |
| Layer 28 | Si | 80 | Si | 80 | Si | 80 | Si | 80 | Si | 80 | Si | 80 | Al₂O₃ | 205 |
| Layer 29 | Ta₂O₅ | 50 | TiO₂ | 50 | Ta₂O₅ | 50 | Ta₂O₅ | 50 | ZrO₂ | 50 | Nb₂O₅ | 50 | Si | 80 |
| Layer 30 | SiO₂ | 189 | SiO₂ | 188 | Al₂O₃ | 80 | MgF₂ | 143 | SiO₂ | 169 | SiO₂ | 133 | Nb₂O₅ | 131 |
| Layer 31 | — | — | — | — | — | — | — | — | — | — | — | — | Al₂O₃ | 85 |
| Layer 32 | — | — | — | — | — | — | — | — | — | — | — | — | SiO₂ | 120 |
| Layer 33 | — | — | — | — | — | — | — | — | — | — | — | — | Si | 80 |
| Layer 34 | — | — | — | — | — | — | — | — | — | — | — | — | Nb₂O₅ | 90 |
| Layer 35 | — | — | — | — | — | — | — | — | — | — | — | — | Si | 80 |
| Layer 36 | — | — | — | — | — | — | — | — | — | — | — | — | SiO₂ | 224 |
| Layer 37 | — | — | — | — | — | — | — | — | — | — | — | — | — | — |
| Layer 38 | — | — | — | — | — | — | — | — | — | — | — | — | — | — |
| Layer 39 | — | — | — | — | — | — | — | — | — | — | — | — | — | — |
| Layer 40 | — | — | — | — | — | — | — | — | — | — | — | — | — | — |
| Layer 41 | — | — | — | — | — | — | — | — | — | — | — | — | — | — |
| Layer 42 | — | — | — | — | — | — | — | — | — | — | — | — | — | — |
| Layer 43 | — | — | — | — | — | — | — | — | — | — | — | — | — | — |
| Layer 44 | — | — | — | — | — | — | — | — | — | — | — | — | — | — |
| Total | — | 5.0 | — | 5.0 | — | 4.2 | — | 5.1 | — | 5.0 | — | 4.9 | — | 4.9 |
| Thickness | | | | | | | | | | | | | | |
| (μm) | | | | | | | | | | | | | | |
| Total | — | 0.8 | — | 0.8 | — | 0.8 | — | 0.8 | — | 0.8 | — | 0.8 | — | 0.8 |
| Thickness | | | | | | | | | | | | | | |
| of Si (μm) | | | | | | | | | | | | | | |

TABLE 3

| | | | | | | | | | Comparative | | | | | |
|---|---|---|---|---|---|---|---|---|---|---|---|---|---|---|
| | Example 8 | | Example 9 | | Example 10 | | Example 11 | | Example 1 | | Comparative | | Comparative | |
| | | Thick- | | Thick- | | Thick- | | Thick- | | Thick- | Example 2 | | Example 3 | |
| | Material | ness | Material | ness | Material | ness | Material | ness | Material | ness | Material | Thickness | Material | Thickness |
| | of Film | (nm) | of Film | (nm) | of Film | (nm) | of Film | (nm) | of Film | (nm) | of Film | (nm) | of Film | (nm) |
| Layer 1 | SiO₂ | 194 | SiO₂ | 209 | SiO₂ | 203 | SiO₂ | 186 | Si | 89.5 | Si | 97.7 | TiO₂ | 170.7 |
| Layer 2 | Si | 80 | Si | 80 | Si | 80 | Si | 78 | TiO₂ | 119.4 | SiO₂ | 197.8 | SiO₂ | 233.5 |
| Layer 3 | ZrO₂ | 90 | TiO₂ | 90 | Ta₂O₅ | 87 | HfO₂ | 70 | Si | 104.4 | Si | 85.1 | TiO₂ | 140 |
| Layer 4 | Si | 80 | Si | 80 | Si | 80 | Si | 81 | TiO₂ | 157.4 | SiO₂ | 290.1 | SiO₂ | 260 |
| Layer 5 | Al₂O₃ | 187 | Al₂O₃ | 195 | Al₂O₃ | 192 | Al₂O₃ | 111 | Si | 113.7 | Si | 105.3 | TiO₂ | 177 |
| Layer 6 | ZrO₂ | 140 | TiO₂ | 108 | Ta₂O₅ | 125 | HfO₂ | 196 | TiO₂ | 159.6 | SiO₂ | 298.8 | SiO₂ | 316.3 |
| Layer 7 | Si | 80 | Si | 80 | Si | 80 | Si | 81 | Si | 111.5 | Si | 101.2 | TiO₂ | 172.4 |
| Layer 8 | Al₂O₃ | 213 | Al₂O₃ | 179 | Al₂O₃ | 205 | Al₂O₃ | 198 | TiO₂ | 154.5 | SiO₂ | 279.6 | SiO₂ | 311.1 |
| Layer 9 | SiO₂ | 300 | SiO₂ | 359 | SiO₂ | 300 | SiO₂ | 199 | Si | 108.1 | Si | 96.6 | TiO₂ | 167.9 |
| Layer 10 | Al₂O₃ | 182 | Al₂O₃ | 180 | Al₂O₃ | 186 | Al₂O₃ | 197 | TiO₂ | 152.6 | SiO₂ | 278.5 | SiO₂ | 295.7 |
| Layer 11 | ZrO₂ | 84 | TiO₂ | 77 | Ta₂O₅ | 89 | HfO₂ | 130 | Si | 109.5 | Si | 100.3 | TiO₂ | 166.4 |
| Layer 12 | Si | 80 | Si | 80 | Si | 80 | Si | 81 | TiO₂ | 157.2 | SiO₂ | 291.3 | SiO₂ | 295.5 |
| Layer 13 | Al₂O₃ | 75 | Al₂O₃ | 117 | Al₂O₃ | 111 | Al₂O₃ | 75 | Si | 112.3 | Si | 103.1 | TiO₂ | 166.3 |
| Layer 14 | ZrO₂ | 171 | TiO₂ | 110 | Ta₂O₅ | 131 | HfO₂ | 159 | TiO₂ | 159.6 | SiO₂ | 296 | SiO₂ | 310.1 |
| Layer 15 | Si | 80 | Si | 80 | Si | 80 | Si | 81 | Si | 112.3 | Si | 103.1 | TiO₂ | 166.5 |
| Layer 16 | ZrO₂ | 71 | TiO₂ | 61 | Ta₂O₅ | 70 | HfO₂ | 82 | TiO₂ | 157.2 | SiO₂ | 291.3 | SiO₂ | 327.1 |
| Layer 17 | Al₂O₃ | 165 | Al₂O₃ | 156 | Al₂O₃ | 166 | Al₂O₃ | 199 | Si | 109.5 | Si | 100.3 | TiO₂ | 170.5 |
| Layer 18 | SiO₂ | 300 | SiO₂ | 350 | SiO₂ | 300 | SiO₂ | 167 | TiO₂ | 152.6 | SiO₂ | 278.5 | SiO₂ | 327.5 |
| Layer 19 | Al₂O₃ | 164 | Al₂O₃ | 156 | Al₂O₃ | 164 | Al₂O₃ | 175 | Si | 108.1 | Si | 96.6 | TiO₂ | 167.5 |
| Layer 20 | ZrO₂ | 77 | TiO₂ | 61 | Ta₂O₅ | 73 | HfO₂ | 101 | TiO₂ | 154.5 | SiO₂ | 279.6 | SiO₂ | 311.6 |
| Layer 21 | Si | 80 | Si | 80 | Si | 80 | Si | 81 | Si | 111.5 | Si | 101.2 | TiO₂ | 163.3 |
| Layer 22 | ZrO₂ | 158 | TiO₂ | 111 | Ta₂O₅ | 126 | HfO₂ | 158 | TiO₂ | 159.6 | SiO₂ | 298.8 | SiO₂ | 303 |
| Layer 23 | Al₂O₃ | 92 | Al₂O₃ | 117 | Al₂O₃ | 120 | Al₂O₃ | 75 | Si | 113.7 | Si | 105.4 | TiO₂ | 164.7 |
| Layer 24 | Si | 80 | Si | 80 | Si | 80 | Si | 81 | TiO₂ | 157.4 | SiO₂ | 290.2 | SiO₂ | 313.9 |
| Layer 25 | ZrO₂ | 109 | TiO₂ | 86 | Ta₂O₅ | 113 | HfO₂ | 114 | Si | 104.4 | Si | 85 | TiO₂ | 167.3 |
| Layer 26 | Al₂O₃ | 148 | Al₂O₃ | 164 | Al₂O₃ | 151 | Al₂O₃ | 186 | TiO₂ | 119.4 | SiO₂ | 198 | SiO₂ | 326.2 |
| Layer 27 | SiO₂ | 300 | SiO₂ | 362 | SiO₂ | 300 | SiO₂ | 262 | Si | 89.5 | Si | 97.7 | TiO₂ | 168.9 |
| Layer 28 | Al₂O₃ | 215 | Al₂O₃ | 180 | Al₂O₃ | 208 | Al₂O₃ | 169 | — | — | — | — | SiO₂ | 325.2 |
| Layer 29 | Si | 80 | Si | 80 | Si | 80 | Si | 81 | — | — | — | — | TiO₂ | 167.4 |
| Layer 30 | ZrO₂ | 155 | TiO₂ | 114 | Ta₂O₅ | 143 | HfO₂ | 186 | — | — | — | — | SiO₂ | 314.2 |
| Layer 31 | Al₂O₃ | 85 | Al₂O₃ | 139 | Al₂O₃ | 83 | Al₂O₃ | 85 | — | — | — | — | TiO₂ | 166.8 |
| Layer 32 | SiO₂ | 120 | SiO₂ | 65 | SiO₂ | 120 | SiO₂ | 123 | — | — | — | — | SiO₂ | 294.4 |
| Layer 33 | Si | 80 | Si | 80 | Si | 80 | Si | 81 | — | — | — | — | TiO₂ | 164.7 |
| Layer 34 | ZrO₂ | 87 | TiO₂ | 91 | Ta₂O₅ | 89 | HfO₂ | 63 | — | — | — | — | SiO₂ | 294.8 |
| Layer 35 | Si | 80 | Si | 80 | Si | 80 | Si | 81 | — | — | — | — | TiO₂ | 168.8 |
| Layer 36 | SiO₂ | 205 | SiO₂ | 216 | SiO₂ | 216 | SiO₂ | 186 | — | — | — | — | SiO₂ | 313 |
| Layer 37 | — | — | — | — | — | — | — | — | — | — | — | — | TiO₂ | 172.1 |
| Layer 38 | — | — | — | — | — | — | — | — | — | — | — | — | SiO₂ | 315.3 |
| Layer 39 | — | — | — | — | — | — | — | — | — | — | — | — | TiO₂ | 175.8 |
| Layer 40 | — | — | — | — | — | — | — | — | — | — | — | — | SiO₂ | 261.9 |
| Layer 41 | — | — | — | — | — | — | — | — | — | — | — | — | TiO₂ | 140.8 |
| Layer 42 | — | — | — | — | — | — | — | — | — | — | — | — | SiO₂ | 235 |
| Layer 43 | — | — | — | — | — | — | — | — | — | — | — | — | TiO₂ | 167 |
| Layer 44 | — | — | — | — | — | — | — | — | — | — | — | — | SiO₂ | 261.9 |
| Total | — | 4.9 | — | 4.9 | — | 4.9 | — | 4.7 | — | 3.5 | — | 4.9 | — | 10.2 |
| Thickness | | | | | | | | | | | | | | |
| (μm) | | | | | | | | | | | | | | |
| Total | — | 0.8 | — | 0.8 | — | 0.8 | — | 0.8 | — | 1.5 | — | 1.4 | — | — |
| Thickness | | | | | | | | | | | | | | |
| of Si (μm) | | | | | | | | | | | | | | |

The refractive indices of the thin films used in Examples and Comparative Examples at a wavelength of 1,490 nm are as follows.

Si thin film: 3.59
SiO₂ thin film: 1.45
MgF₂ thin film: 1.36
Al₂O₃ thin film: 1.64
Ta₂O₅ thin film: 2.13
Nb₂O₅ thin film: 2.23
ZrO₂ thin film: 2.04
TiO₂ thin film: 2.29
HfO₂ thin film: 2.03

The wavelength separation films of Examples 1 to 11 and Comparative Examples 1 to 3 thus produced each were evaluated for optical characteristics.

FIGS. 5 to 18 are graphs showing the optical characteristics of the wavelength separation films of Examples 1 to 11 and Comparative Examples 1 to 3. The correspondence between the wavelength separation films and the graphs is shown in Table 1. In the graphs showing optical characteristics, the abscissa shows the wavelength (nm), and the ordinate shows the transmittance (%) The thin line curve labeled “S-45°” shows the relationship between wavelength and transmittance for the S polarized component incident at 45°. The thick line curve labeled “P-45°” shows the relationship between wavelength and transmittance for the P polarized component incident at 45°. The thin dotted line curve labeled “S-43°” shows the relationship between wavelength and transmittance for the S polarized component incident at 43°. The thick dotted line curve labeled “P-43°” shows the relationship between wavelength and transmittance for the P polarized component incident at 43°.

Comparative Example 1 corresponds to a conventional wavelength separation film having a Si film and a SiO₂ film laminated, and as shown in FIG. 16, the wavelength separation film of Comparative Example 1 exhibits a large separation width between the P polarized component and the S polarized component although the wavelength shift in transmittance on deviation of the light incident angle is small.

Comparative Example 2 corresponds to a conventional wavelength separation film having a Si film and a TiO₂ film laminated, and as shown in FIG. 17, the wavelength separation film of Comparative Example 2 exhibits a large wavelength shift in transmittance on deviation of the light incident angle. In FIG. 17, only the P polarized component is shown, but the S polarized component is not shown in the graph since it is positioned on the longer wavelength side beyond 1,800 nm. Accordingly, the wavelength separation film of Comparative Example 2 exhibits a significantly large separation width between the P polarized component and the S polarized component.

Comparative Example 3 corresponds to a conventional wavelength separation film having a TiO₂ film and a SiO₂ film laminated, and as shown in FIG. 18, the wavelength separation film of Comparative Example 3 exhibits a large wavelength shift in transmittance on deviation of the light incident angle and a large separation width between the P polarized component and the S polarized component.

In Examples 1 to 11 according to the invention, as shown in FIGS. 5 to 15, the wavelength separation films each exhibit a small wavelength shift in transmittance on deviation of the light incident angle and an enhanced stopband. The wavelength separation films each also exhibit a small separation width between the P polarized component and the S polarized component.

According to the invention, the wavelength shift in transmittance on deviation of the light incident angle can be decreased, and the separation width between the P polarized component and the S polarized component can be decreased.

Furthermore, as shown in Tables 2 and 3, the wavelength separation films of Examples 1 to 11 according to the invention can decrease the total number of films laminated and can decrease each of the films laminated in thickness, as compared to the conventional wavelength separation films of Comparative Examples 1 to 3. Accordingly, the wavelength separation films according to the invention can decrease the total thickness.

Moreover, the wavelength separation films of Examples 1 to 11 according to the invention can decrease the total thickness of Si, and thus can decrease the transmission loss due to absorption with Si.

### Examples 12 and 13

A wavelength separation film of Example 12 was produced with the same film structure as in Example 10 shown in Tables 1 and 3 except that the refractive index of the Si thin film was 2.88.

A wavelength separation film of Example 13 was produced with the same film structure as in Example 10 except that the refractive index of the Si thin film was 4.19.

The refractive index of the Si thin film was changed by controlling the vapor deposition rate for forming the Si thin film. The Si thin film having a refractive index of 4.19 was formed by increasing the vapor deposition rate of the Si thin film, and the Si thin film having a refractive index of 2.88 was formed by decreasing the vapor deposition rate of the Si thin film.

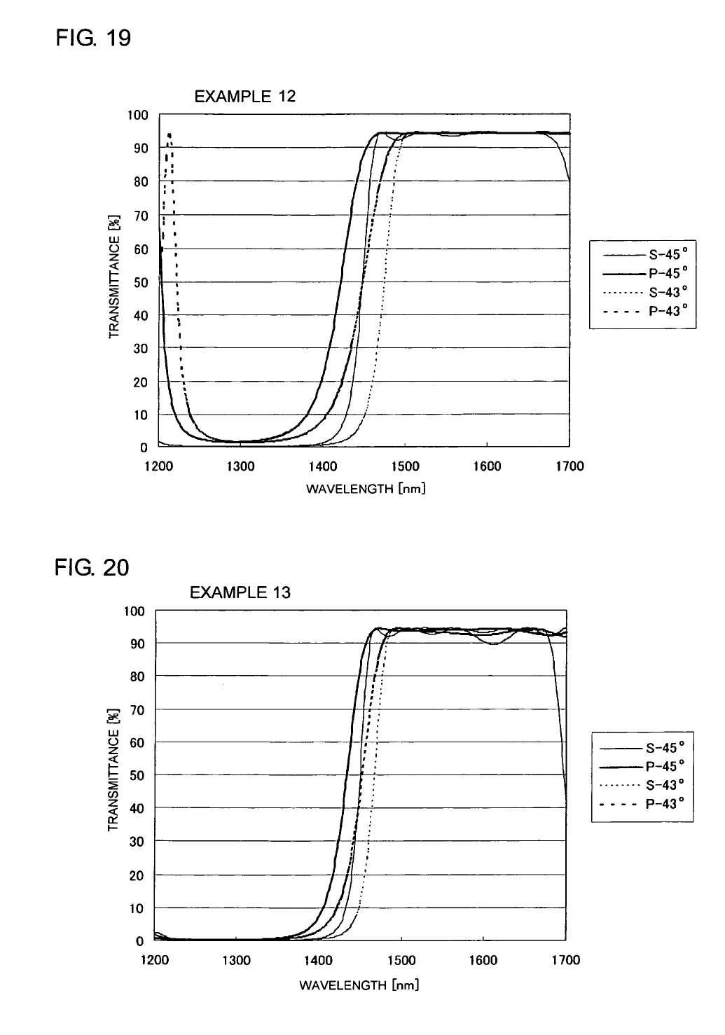

FIG. 19 shows the optical characteristics of the wavelength separation film of Example 12, and FIG. 20 shows the optical characteristics of the wavelength separation film of Example 13.

As shown in FIG. 19, the wavelength separation film of Example 12 exhibits a narrow stopband as compared to the other examples owing to the low refractive index of the Si thin film. The wavelength separation film of Example 12 exhibits a large separation width between the P polarized component and the S polarized component.

As shown in FIG. 20, the wavelength separation film of Example 13 exhibits large ripple in the pass band owing to the high refractive index of the Si thin film.

As having been described above, according to the invention, the total number of the laminated films can be decreased, the thickness of each of the laminated films can be decreased, the separation width in optical characteristics between the P polarized component and the S polarized component formed from light incident on the inclined wavelength separation film can be decreased, the wavelength shift widths of the passband and the stopband on deviation of the light incident angle can be decreased, the stopband can be enhanced as compared to conventional ones, and the transmission loss due to absorption with Si can be decreased by decreasing the total thickness of Si.

What is claimed is:

1. A wavelength separation film having a structure comprising plural thin films laminated to each other including a first thin film comprising a high refractive index material, a second thin film comprising a low refractive index material, and a third thin film comprising a material having an intermediate refractive index that intervenes between the refractive index of the high refractive index material and the refractive index of the low refractive index material,
the high refractive index material being silicon, the low refractive index material being at least one selected from silicon oxide, magnesium fluoride and aluminum oxide, and the material having an intermediate refractive index being at least one selected from titanium oxide, tantalum oxide, niobium oxide, zirconium oxide, hafnium oxide and aluminum oxide.

2. The wavelength separation film as claimed in claim 1, wherein the first thin film, the second thin film and the third thin film are laminated in such a manner that the first thin film is adjacent to the second thin film or the third thin film.

3. The wavelength separation film as claimed in claim 1, wherein the third thin film comprises plural thin films laminated to each other.

4. The wavelength separation film as claimed in claim 1, wherein the wavelength separation film has a total number of the thin films laminated in a range of from 20 to 50 layers.

5. A filter for optical communication comprising the wavelength separation film as claimed in claim 1, the wavelength separation film being disposed to be inclined with respect to a light incident direction, thereby transmitting light having a wavelength in a passband of the wavelength separation film and reflecting light having a wavelength in a stopband of the wavelength separation film.

6. The filter for optical communication as claimed in claim 5, wherein the wavelength separation film is disposed to be inclined with respect to the light incident angle at an angle of from 40 to 50°.
